(19) United States
(12) Patent Application Publication
(10) Pub. No.: US 2011/0015309 A1
(43) Pub. Date: Jan. 20, 2011

(54) THERMOPLASTIC STARCH COMPOUNDS

(75) Inventors: Erich Brocker, Kirchberg (CH); Martin Halter, Uzwil (CH); Ernst Schwab, Wil (CH)

Correspondence Address: THE NATH LAW GROUP, 112 South West Street, Alexandria, VA, 22314, US

(73) Assignee: SWISS CAPS RECHTE UND LIZENZEN AG, Kirchberg (CH)

(21) Appl. No.: 12/921,226

(22) PCT Filed: Mar. 24, 2009
(86) PCT No.: PCT/EP2009/053405

§ 371 Date: Sep. 7, 2010

(30) Foreign Application Priority Data
Apr. 10, 2008 (EP) 08103488.6

(51) Int. Cl. C08L 3/00; C08L 89/00; B29C 47/88; B29C 39/02

(52) U.S. Cl. 524/18; 524/47; 264/211.12; 264/310

(57) ABSTRACT

The invention relates to a homogeneous, non-dried, melt-extruded thermoplastic compound containing 30-60% by weight dry substance of native or chemically modified starch, maximum 11% by weight dry substance of at least one other biopolymer selected from the group consisting of carrageenan or a different polysaccharide or a protein, 20-45% by weight dry substance of at least one softener and a maximum of 20% by weight water. Said compound can be used, advantageously, to produce molded bodies such as soft capsules with increased impact resistance.

The present invention relates to an improvement in water-soluble, starch-containing materials for producing bands by means of melt extrusion, and to the use of these bands/films as coating material for producing molded bodies by means of the rotary die process.

The present invention relates to molded bodies, in particular capsules, which serve as administration form for nutritionally physiologically or pharmacologically effective, active substances—primarily for oral, rectal, vaginal application. The molded bodies according to the invention can, however, also comprise dosed substances for technical applications, such as solvents, lubricants, detergents, cosmetics, colored pastes etc. Preferably, the present invention relates to soft capsules made of two inseparably heat-sealed shell parts.

According to the present invention, a molded body is to be understood' as meaning a product with a core/shell structure in which the shell surrounds the core in an essentially complete and uniform manner, the product being produced in one processing step through portionation and coating of the core. A representative example of a shaped body according to the invention is a soft capsule.

Soft capsules can be realized only with a few production processes:
a) coacervation,
b) dripping process (coextrusion without mechanical shaping process),
c) molding the shell and then filling and sealing.

Within the context of the present invention, soft capsules have a shell made of a flexible film and are produced by a process according to c). Preferably, this flexible film consists of thermoplastic material which is further preferably also additionally water-soluble.

To increase the mechanical flexibility, the material can additionally comprise a softener, i.e. a low molecular weight substance with a low vapor pressure, i.e. a “solvent”, which remains permanently in the material. A specific softener for water-soluble polymers can be named as water itself. As a rule, water is a good softener for water-soluble polymers, but has a relatively high volatility (high vapor pressure, relatively low enthalpy of evaporation). Since water vapor is practically continually present in the atmosphere and thus in the ambient air of the molded body, water is a softener at least for the water-soluble polymer of the coating material since it is absorbed by the coating material as a result of sorption. Moreover, water is at least a solvent/softener of a temporary nature for all at least partially water-soluble polymers: it is possible to produce therefrom solutions (solvent in excess) of the polymer in water or “inverse solutions” (polymer in excess, thus softened polymers). In contrast to permanent softeners, however, the temporary softener water can be removed by drying and/or introduced again as a result of sorption. The mechanical properties of such materials are therefore dependent on the sum of permanent and temporary softener.

The production of molded bodies with the help of the rotary die process is the most economical and most widespread method for realizing different shapes, sizes and fill materials, the molded bodies generally having a diameter of from 2 to 20 mm. In this process, the coating is formed by heat-sealing two films, corresponding to two shell halves, around a liquid or solid core. The process is thus in principle different from dripping processes in which the core and the shell are formed simultaneously as a result of pulsed, concentric coextrusion of two immiscible phases.

The construction of the machine required for the rotary die process requires certain minimum properties of the shell material, i.e. of the cold and hot film, for the processing of the films. For the cold film e.g. modulus of elasticity, impact resistance; for the hot film—i.e. directly before or during the operation of molding and heat-sealing—adequate tensile stress, elongation at break, heat-sealability (melt flow index) etc. The heat-sealability is achieved by sufficiently increasing the melt flow index through incremental increase of the temperature at the heat-sealing site and increased pressure as a result of the seam-forming tools (lap seal). Sufficiently high tensile strength coupled with the lowest possible tackiness up to just before the “melting” or heat-sealing temperature range should be present. This is best ensured using thermoreversible gels made of water-soluble biopolymers. The rotary die technique was therefore originally developed for aqueous gelatin melts (sol/gel transition at ca. 44° C.). Gelatin-free materials based on the same principle, i.e. the sol/gel transition, were realized from aqueous carrageenan or gellan films. These are thermoreversible gels with a sol/gel transition at ca. 60-75° C. Such films comprise ca. 35 to 95% water, depending on whether only the gel former or also a fill material, that thickens the otherwise excessively liquid sol, such as starch, dextrins, guar, carob seed flour etc. are added.

These homogeneous, aqueous, thermoreversibly gelling biopolymer solutions are essentially poured out of flat nozzles at atmospheric pressure. By reducing the water fraction in the biopolymer solutions and increasing the extrusion pressure, it is possible to also pour more viscous melts. However, it is then necessary first to prepare a homogeneous aqueous solution from the biopolymer, softener and aggregates/thickener. This process, which can be realized economically most simply in a melting tank (up to 6 bar, up to 130° C.), can only be realized above at least ca. 30-40% total water fraction of the processable melts on account of the high viscosity.

By using integrated mixing/heating and shaping installations, such as a single- or twin-shaft extruder with coupled flat nozzle, it is possible to process thermoplastic compounds at increased pressures (50-300 bar) and increased temperatures (80-300° C.) to give films. The presence of (temporary or permanent) softeners during the processing to give a homogeneous melt and shaping to give a film is, depending on the properties of the polymer itself—unnecessary in some circumstances, or can be restricted to the amount which is necessary for the mechanical properties of the material in the cold state.

Thus, starch can be processed in a water-free manner or by means of high fractions of softeners (EP-A-1 103 254) by extrusion to give a product with the mechanical properties (modulus of elasticity, elongation at break) required for the capsule molding and also the end application, without gel formers having to be present in aqueous solution such as gelatins, carrageenans or other biopolymers.

In practice, however, it has been found that compounds of this type exhibit unsatisfactory impact resistance behavior. The impact resistance of a plasticized starch as described in EP-A-1 103 254 is only adequate to a limited extent for practical use as a coating material of capsules. This applies both to starches with a high amylase content and to those with a high amylopectin content. It is true that, through selection of the softener and adjustment of the equilibrium moisture to the average kinetic moisture in interiors of the market climatic zone (e.g. climatic zone 1: 19-20° C., 45% RH) and the drop in glass transition temperature Tg resulting therefrom, it is possible to improve the mechanical properties. The corresponding molded bodies, on account of the small dimensions and weights (which are limited ca. to 100-2000 mg total weight and a total volume of 0.2-2 ml), are also only exposed to mechanical pressure to a limited extent. Upon lowering the temperature and/or removing the moisture, the impact resistance is therefore scarcely adequate any longer for the intended use as soft capsule with a liquid content.

This is because molded bodies for use as food supplements or medicaments, especially also for oral intake, are exposed in the packaging on the transportation and distribution route to the following typical average physical stresses: during storage in interiors, temperatures of 15-30° C. at an atmospheric humidity of about 20-75% RH are generally acting upon the molded bodies in packaged form. During transportation in a vehicle without air conditioning, temperatures of 0-35° C. at an atmospheric humidity of about 50-90% generally act on the molded bodies. These guideline values can also be exceeded, e.g. in the event of inappropriate storage in a refrigerator or in an overheated vehicle.

Moreover, molded bodies of this type have to be able to withstand a mechanical force of ca. 30 N (as occurs when pressing the molded body out of a blister pack) or a shock stress of 0.05 Nm/s (when a capsule drops from about 1.5 m).

Attempts hitherto to increase the impact resistance have not led to the desired success. Thus, EP-A-1 258 242 describes the production of thermoplastic compounds by means of controlled regulation of the moisture of the compound. Although certain mechanical properties were improved as a result, it was found that despite an adequately low glass transition of at least 30° C. below the use temperature, the impact resistance of the starch was improved only insignificantly.

The use of starch with a high amylase content or high amylopectin content could also not satisfactorily optimize the impact resistance of the thermoplastic starch.

Mixtures of starch and other biopolymers such as carrageenans have already been proposed in the prior art for producing molded bodies. Even in EP-A-1 103 254, the “group of physically and/or chemically modified biopolymers comprising cellulose, in particular partially hydroxypropylated cellulose, alginates, carrageenan, glactomannans, glucomannans, casein” are listed in general as possible aggregates for the basic compound of the thermoplastic starch. However, there are no corresponding working examples which would demonstrate a possible advantage of such mixtures.

In U.S. Pat. No. 6,340,473 and U.S. Pat. No. 6,949,256, starch is used as polymeric filler of average molecular mass together with the gel former carrageenan and a softener in an aqueous solution for producing molded bodies. In U.S. Pat. No. 6,949,256, a mixture of iota- and kappa-carrageenan is proposed for this in order to overcome the problems that arise with the sole use of kappa-carrageenan. Large amounts of water of significantly more than 20% by weight are used. U.S. Pat. No. 6,340,473 describes coating materials for soft capsules which, besides modified starch, comprise a high fraction of 12-24% by weight iota-carrageenan.

EP-A-1 448 608 also describes mixtures with a large fraction of more than 60% kappa-carrageenan, where the water fraction of the overall mixture is 50-95%, but preferably 60-85%.

U.S. Pat. No. 4,859,484 describes the processing of starch with hydrocolloids such as guar gum and carob seed flour following preswelling in water such that processing water fractions of >200% result. Here too, comparatively large fractions of gums are taught.

The two last documents do not describe that homogeneous mixtures have been prepared. It is sufficiently known to the person skilled in the art that the preparation of aqueous solutions of highly polymeric substances such as carrageenan, gellan, cellulose ethers and other water-soluble biopolymers depends very critically on the water temperature, the water activity and the particle size of the polymer. Thus, in most cases it is recommended to undertake a wetting of the biopolymer with nonaqueous liquids (such as e.g. glycerol) or water of low temperature, or to disperse the biopolymer extremely quickly in water. Biopolymers in a concentrated dry state form extremely strong hydrogen bridges. Upon water contact, no dissolution behavior, but only swelling behavior, can therefore firstly be established. Depending on the water supply, simple hydrations are formed on the polymer chains (many hydrogen bridges of the biopolymer are retained). Only upon a very much higher degree of hydration (“multiple layers of water between the chains”) does the mobility of the polymer increase. In the case of thermoreversible gels, certain residual bonds (in the case of carrageenan, helical stretches) are retained in the cold state even in the case of extremely high water dilutions. It is therefore not necessarily clear to the person skilled in the art how a mixture of starch, softener and biopolymer can be processed to give a homogeneous thermoplastic compound.

The processing of solutions of carrageenan or other hydrocolloids to give complex mixtures with starch, microcrystalline cellulose, or lactose in the granulation process with the help of “extruders” (such as, for example, “LCI twin dome” granulators to give pellets) is not decisive for this invention since while the procedures known in the pharmaceutical industry under the name “extrusion” often involve apparatuses with two screws which very efficiently mix pulverulent and crystalline mixtures and/or are able to mix the latter with liquid and viscous binder solutions, within the context of this invention, these processing steps are not referred to as “melt extrusion” since the majority of the substances are not converted to the plastic state by means of increased pressure, elevated temperature and shear forces, and in no case does a “homogeneous” product result from these processes. The terms used here for elevated temperature, increased pressure and short residence time do not apply to such granulation processes.

EP-A-1 105 107, EP-A-1 105 108 and WO 2004/091533 describe the production of molded bodies, namely permanent capsules comprising softeners, which have been prepared using the rotary die process. Here, it is essential that the hot aqueous solution produced initially solidifies as a result of the sol→gel transition and can thus be fed to the encapsulation machine. Furthermore, it is important that the hot aqueous solution (sol) comprises as much as possible of an aggregate compound that does not disturb the processing and mechanical properties in the subsequent dry state since this increases the mechanical stability in the gel state and only just permits a sealing of the two bands. The sharp sol→gel transition of a pure aqueous carrageenan solution becomes broader or is attenuated as a result of such additives, meaning that slight temperature differences between band inside and band outside permit a clean seam formation with small increments in temperature and pressure. Such systems comprise kappa-carrageenans, iota-carrageenans and/or kappa-II carrageenans.

None of the documents cited above describes advantageous impact resistance properties of the compositions disclosed therein. None of the documents relates to compounds of starch and a biopolymer such as a carrageenan produced by melt extrusion.

It was the object of the present invention to provide thermoplastic starch-containing compounds as film-forming material for producing molded bodies such as soft capsules which have a satisfactory impact resistance under varying ambient conditions and can be produced in a simple manner.

This object is achieved according to the present invention by a homogeneous, undried, melt-extruded thermoplastic mass comprising 30-60% by weight dry substance of native or chemically modified starch, at most 11% by weight dry substance of at least one further biopolymer selected from the group consisting of carrageenan or another polysaccharide and a protein, 20-45% by weight dry substance of at least one softener and at most 20% by weight water.

According to the present invention, the water content refers to the total water content of the compound and thus includes both the amount of added water and also the water content present in the components used.

Surprisingly, it has been found that compounds of this type have a comparatively high impact resistance and retain this to a satisfactory degree even upon increasing the temperature and removing moisture (lower atmospheric humidity in the surrounding area).

The processing of starch/carrageenan compounds under low-water conditions has hitherto not been described. Likewise, the prior art specified above in each case specifies a very specific carrageenan with/without stabilizing buffer system which does not have to be present according to the invention.

It has entirely surprisingly been found that using low-water thermoplastic processing at increased pressure and elevated temperature with a short residence time of starch together with biopolymers, in particular of carrageenans, it is possible to obtain impact-resistant compounds.

According to the aforementioned prior art, starch/carrageenan mixtures are processed in the form of thermoreversibly gelling compounds with a high water fraction at temperatures of 60-80° C. Upon processing, compounds of this type have a dynamic viscosity around 10⁴ Pa·s. The compound described according to the invention, by contrast, under processing conditions has a dynamic viscosity in the region of 10⁹ Pa·s and cannot be processed by the above method (pouring of films). Although the composition of the known starch/carrageenan mixtures (after drying) may be similar to the compound described according to the invention, it is not identical material. It can be attributed to the different processing that the material described according to the invention has a different microstructure and corresponding different mechanical and optical properties.

Within the context of the present invention, the term “homogeneous” or “homogenized” is to be understood as meaning a material or compound which is produced by melt extrusion and has essentially the same chemical and physical composition and nature at each point within the material. Slight deviations can arise on the particular material or molding surfaces as a result of the absorption of atmospheric moisture. The compounds according to the invention produced in the extruder are moreover generally characterized by slight opacity. This opacity is a sign of “microscopic inhomogeneities” on a molecular level. This is explained by the fact that as a result of the melting of native starch grains and/or granules of pregelled starch under increased pressure and temperature and with defined water/softener activity, although a homogeneous distribution of the starch and softener molecules takes place at a macroscopic level, by contrast at a microscopic or molecular level, so-called nodes of 1,4-polyglucose double helices or so-called blocklets appear to remain (see Donald, Perry, Waigh: “The impact of internal granule structure on processing and properties”, in Barsby, Donald, Frazier (eds.), Starch: Advances in structure and function, Royal Society of

Chemistry, Cambridge 2001). A (macroscopically) homogeneous mixture of thermoplastically melted “grains” of starch and biopolymer can therefore on a molecular level consist of domains, the majority having one component, and also domains with homogeneously mixed fractions of both components, and also molecule chains running through from node to node.

Without wishing to be bound to one explanation, the present inventors assume that these domains (microscopic inhomogeneities) could serve as so-called “crumple zones”, through which an increase in impact resistance is effected.

Within the context of this invention, the term “melt extrusion” refers to a process in which the majority of the substances used are melted and converted to the plastic state by means of increased pressure, elevated temperature and shear forces.

Within the context of this invention, low-water is to be understood as meaning that the biopolymer and the starch are metered in with water fractions (moistures) corresponding to a storage and marketing equilibrium moisture (this means ca. 6-12% for carrageenans, 8-15% for pregelatinized starch and 13-22% for native starches corresponding to an equilibrium moisture of aw=0.30 to 0.60 (30-60% RH)), and for the actual processing in the twin-screw extruder at elevated temperature and increased pressure and only a short residence time, water fractions of less than 20% are added. The total water content from the water present in the components as equilibrium moisture and added water is at most 20%, more preferably less than 15%.

Within the context of this invention, elevated temperatures are temperatures of at least 40° C. above room temperature, i.e. product temperatures of 60-150° C. The temperature of the extruder heating segments is to be assumed as corresponding approximately to the product temperature.

Within the context of this invention, increased pressure is to be understood as meaning product pressures of from 10 to 300 atm. The pressure at the extruder outlet opening (nozzle) here is to be assumed as corresponding approximately to the maximum product pressure.

Within the context of this invention, increased shear stress is to be understood as meaning a processing of the compounds according to the invention, preferably in a twin-screw extruder, with an energy input of from 2 to 10 kWh. This corresponds to a specific energy of from about 0.15 to 0.7 kWh/kg of compound to be processed. The specific shear energy (shear stress) according to the present invention is typically between 100 000 and 500 000 Pa.

The present invention relates to an undried compound. This is to be understood as meaning a compound which does not pass through a drying stage during its production and/or processing. According to the present invention, a drying stage is spoken of when the aw value of the homogeneous material decreases by more than 0.1 during this process stage. The aw value (the water activity of a system) is defined as the volatility of water from this system divided by the volatility of pure water.

Within the context of this invention, a short residence time is understood as meaning a residence time between first contact of all components after metering into the extruder and the exit of the molten homogeneous mixture from the extruder of at most 5 minutes, preferably 3 minutes, more preferably 2 minutes.

Within the context of the present invention, impact resistance is to be understood as meaning the impact resistance in accordance with DIN EN ISO 8256. Here, films (bands) with a thickness of ca. 400-800 μm, as are required for producing soft capsules according to the rotary die process, are conditioned, punched to give test pieces and, by means of an impact pendulum at fixed impact rates, investigated as to brittleness or toughness at a high tensile strain rate. Here, the failure behavior on soft capsules should be tested under different climatic conditions (such as warm/dry, cold/humid, normal or warm/humid).

According to the present invention, compounds of starch and at least one further biopolymer are used.

Within the context of this invention, starch is understood as meaning linear 1,4-polyglucans (amylose), branched 1,6-/1,4-polyglucans (amylopectin) or combination thereof to give a very large branched polymer with a weight of up to more than 1 million daltons, as can be obtained as so-called native starches from corn, waxy corn, rice, potato, tapioca (manihot), arrowroot, sorghum, millet, oats, wheat, hard wheat, rye, barley, buckwheat, peas, lentils, bean, butterbean, mungo bean, peanut, maranta, curcuma, canna, pearl sago, horse chestnut, banana, Dioscorea, batata or other plants.

In a preferred embodiment, the starch is selected from the native starches from potato, corn, waxy corn, rice and tapioca.

According to the invention, starch is also understood as meaning the so-called pregelatinized or cold-water-soluble starches, the natural grain structure of which was destroyed in the main by swelling in water and heating, to give a structureless, heavily water-containing compound, and were then processed by drying over rolls, spraying or similar processes to give a pulverulent, granular or flaky state. In one preferred embodiment, the starch is a pregelatinized potato or corn starch.

According to the invention, starch is also understood as meaning the chemically modified starches, the polysaccharide chains of which have been modified by introducing one or more modifications such as hydroxypropylation, acetalization, phosphatidation or by oxidation. In one preferred embodiment, the starch is a hydroxypropylated potato starch or tapioca starch.

In addition to starch, the compounds according to the invention comprise at least one further biopolymer selected from the group consisting of carrageenan, gellan or a protein.

Within the context of this invention, carrageenan is understood as meaning long-chain linear, anionic hydrocolloids (polysaccharides, from various types of red algae, in particular from Irish moss (Chondrus crispus), Eucheuma spinosum (iota-carrageenan), Kappaphycus cottonii (kappa-carrageenan)) following appropriate extraction in an alkaline medium and precipitation with ethanol.

According to the present invention, however, PES (Processed Eucheuma Seaweed) are also encompassed. These are semi-refined carrageenans (E407a) which are produced directly by alkaline extraction (without ethanol precipitation).

The different carrageenan types differ primarily by virtue of the fraction of galactose and 3,6-anhydrogalactose and also by virtue of the number of sulfate groups present. Known gel-forming carrageenans are only κ- and τ-carrageenan, whereas λ-carrageenan has only a thickener effect and μ- and ν-carrageenans can be considered precursors to κ- and τ-carrageenan since they are largely converted to these types during the alkaline extraction. Kappa-iota-hybrid carrageenans have also been described. Moreover, kappa-II-carrageenan has been used in poured soft capsule films. The fraction of carrageenan types in the finished carrageenan is thus dependent both on the type of algae used and also on the production process. For this reason, commercial carrageenan is also never absolutely pure individual types.

κ-Carrageenan gels with potassium ions in aqueous solution to give a solid and brittle gel, whereas with calcium ions it converts to a solid, elastic and low-syneresis gel. iota-Carrageenan gels with calcium ions in aqueous solution. iota-Carrageenan is also only cold-soluble as sodium salt and, as the calcium or potassium form, requires likewise higher temperatures.

According to the present invention, however, it is also possible to use other biopolymers instead of carrageenans. These are for example
polysaccharides of the type
a) gel formers, such as agar (Gracilaria, Gelidiopsis, Gelidium, Hypnea and Sphaerococcus species), gellan, hsian-tsao (from mesone procumbens), curdlan (beta(1,3)-glucan), and furcellan (from Furcellaria fastigiata),
b) specific starch degradation products and modifications, such as pullulan (polymaltotriose),
c) polysaccharides from fruits such as carob seed flour (carob, GM=galactomannan), guar (GM), tara gum, psyllium seed gum, and Konjac (Glucomannan),
d) tree sap gums (exudates) such as: gum arabic, tamarind gum, Khaya grandifolium gum, ghatti (from Anogeissus Lati-folia), tragacanth (from Astralgus species), and karaya (from Sterculia species),
e) pectins (methylated poly-galacturons),
f) alginates (poly-mannuron/gulurons) and salts thereof (which can also gel with divalent cations),
g) exocellular polysaccharides of microorganisms, such as xanthan (beta-1,4-glucan) (B-D-glucose, a-D-mannose and a-D-glucoronic acid 2:2:1), scleroglucan (from Sclerotium rolfsii), schizophyllan (from Schizophyllan commune), succinoglycan (from Rhizobium meliloti), rhamsan (from Sphingomonas paucimobilis), welan, and sphingan,
polyaminosaccharides such as chitosan (beta-1,4-poly-D-glucosamine) and hyaluronan (glycosaminoglycan)
proteins such as
a) vegetable proteins (also fractionated) from soya, wheat, oats, barley, rye, potato, peas and corn or flours thereof (i.e. starch plus protein in a natural mixture),
b) animal proteins such as casein, milk protein, egg albumin.

According to the invention, it is also possible to use mixtures of different biopolymers, in which case the total amount of biopolymer has to be within the stated ranges.

According to the present invention, the starch and the further biopolymer are to be used in a certain ratio relative to one another. The starch is to be used in an amount of 30-60% by weight dry substance, preferably 33-55% by weight dry substance. The additional biopolymer is to be used in an amount of at most 11% by weight dry substance, preferably 2 to at most 11% by weight dry substance, yet more preferably 3 to 10.5% by weight dry substance.

According to the invention, dry substance is to be understood as meaning the amount of the corresponding substance in the dry state (i.e. without the customarily present equilibrium moisture described above).

In addition, the compounds according to the invention comprise at least one permanent softener. Within the context of this invention, permanent softeners are understood as meaning short-chain substances (i.e. substances with a molecular weight of <1000 daltons) which have a high solubility parameter and bring about a reduction in the melting point of the starch. The solubility parameter concept was proposed by Hildebrand and Scatchard and further developed particularly in the field of polymers (see e.g. Handbook of solubility parameters and other cohesion parameters, 2nd edition, A.F.M. Barton ed., CRC Press, Boca Raton (1991)). Such softeners are already known from U.S. Pat. No. 5,362,777. Particular preference is given to softeners which are approved as food additives or at least have no negative health effects as pharmaceutical auxiliaries. Such softeners are selected from the group consisting of 1,2-propylene glycol, 1,3-propylene glycol, glycerol, lower polyethylene glycols (PEG), polyglycerols, sorbitol, maltitol, erythritol, xylitol, mannitol, isomaltitol, lactitol, maltotriitol, hydrogenated oligosaccharides, sorbitans, glucose, glucose syrup, dianhydrosorbitol, isosorbides, maltol, isomaltol, maltodextrin, N-methylpyrrolidone, triethyl citrate and glycerol triacetate.

Within the context of this invention, preference is given to softeners which, on account of their molecular weight and vapor pressure, exhibit the least possible migration, enter into high interaction with the hydroxyl groups of the starch and biopolymers, and also have a low crystallization tendency, are physiologically acceptable, and have a low sorption at ambient humidities of more than 30% RH and a high sorption at humidities of less than 30% RH. These softeners are preferably selected from the group consisting of glycerol, sorbitol, maltitol and hydrogenated starch degradation products.

According to the invention, the at least one softener is present in the compound in an amount of from 20 to 45% by weight dry substance, preferably 25 to 45% by weight dry substance.

Moreover, further customary additives can also be added to the compound according to the invention. Additives of this type are known to the person skilled in the art. For example, an internal slip agent and mold release agent can be added which is selected from the group consisting of lecithins, mono-, di- or triglycerides of food fatty acids, polyglycerol esters of food fatty acids, polyethylene glycol esters of food fatty acids, sugar esters of food fatty acids and food fatty acids.

Food fatty acids are understood as meaning the monocarboxylic acids occurring as acid components of the triglycerides of natural fats. They have an even number of carbon atoms and have an unbranched carbon structure. The chain length of the fatty acids varies from 2 to 26 carbon atoms. A large group of the fatty acids are saturated fatty acids.

The slip agent and mold release agent is present in the mixture preferably in a range from 0 to 4% by weight, based on the total weight of the mixture. In one preferred embodiment, the mixture comprises glycerol monostearate.

Furthermore, at least one aggregate can also be added to the mixture in a weight range from 0.1% by weight to 15% by weight, preferably from 0.1% by weight to 5% by weight, based on the total weight of the mixture. The aggregates are selected from the group consisting of carbonates and hydrogencarbonates of the alkali metal and alkaline earth metal ions, further disintegration auxiliaries, fillers, dyes, antioxidants, or physically and/or chemically modified biopolymers, in particular polysaccharides and vegetable polypeptides.

The opacity of the homogenized compound is achieved e.g. preferably with the addition of titanium dioxide or iron oxides (or similar substances) as filler.

The disintegration auxiliaries added for rapid disintegration of the capsule shell are preferably calcium carbonate and amylases.

As explained above, the compounds according to the invention are characterized in that only at most 20% by weight water is added externally (i.e. in addition to the moisture content of the other components). Such a small amount of water can only be realized by producing the compounds according to the invention using a special melt extrusion process.

The processing of the individual components to homogeneous, thermoplastic compounds takes place according to the invention in a device that can be used for the simultaneous mixing, heating and shearing of all components, such as a twin- or single-screw extruder. Devices of this type are sufficiently known to the person skilled in the art.

The person skilled in the art also differentiates the use of an extruder for intimate mixing, shearing and melting in clear terms from the use of an extruder merely as a pump for a highly viscous compound for promoting and achieving a uniform pressure. The person skilled in the art will therefore configure the configuration of a screw in a single-screw extruder for melting and transportation in a completely different way to the counter- or co-rotating screw pair in a twin-screw extruder for producing compounds.

In the same way, a person skilled in the art stipulates the processing conditions which are necessary for achieving an air-free, homogeneous thermoplastic mass. The delivery amount, through-flow time, the temperature profile and the specific shearing are to be adjusted exactly in order to achieve useful results.

In order to be able to introduce the energy (temperature) and shear forces required for the melting and kneading operation, an adequate residence time must also be ensured according to the invention as well as a screw configuration suitable therefor. Of suitability for this are particularly co-rotating twin-screw extruders with a length (measured in multiples of the diameter) of at least L/D >20, preferably >36, more preferably >40.

During the processing of biopolymers to homogeneous compounds it was known, as explained above, that the high shear during the processing in extruders can be undertaken only at a very high water content without damage to the polymer and the water activity must be very high in order to achieve homogeneous and complete swelling. It was therefore completely surprising even for the person skilled in the art that, under certain process conditions, the processing can also be undertaken under very low-water conditions in order, in so doing, to arrive directly at the low-water products required according to the invention.

According to the present invention, the process is carried out in a two-screw extruder typically at
shear forces from 0.15 to 0.70 kWh/kg of compound
a temperature profile of 100-130° C.
a maximum temperature of 150° C.
residence times of from 1 to 3 minutes
in the presence of a permanent plasticizer and at most 20% by weight additionally added water.

This gives homogeneous thermoplastic compounds with greatly improved impact resistance compared with analogous compounds made of pure starches.

The process for producing the homogeneous thermoplastic compound and the subsequent processing to give soft capsules in the rotary die process is already outlined in the disclosure in EP-A-1 103 254, to the corresponding contents of which reference is hereby made. According to the present invention, however, the above process parameters should be maintained.

Moreover, according to the present invention, the extruded compound strands are introduced into a cooling medium for rapid cooling. The cooling medium is preferably a non-volatile, low flammability cooling medium that is not harmful to the environment and is suitable for food, for example medium-chain triglycerides (i.e. triglycerides with a chain length in the fatty acid fraction of from 6 to 18 carbon atoms). According to the present invention, it has surprisingly been found that by using such a cooling medium, a cooling of the compound according to the invention is possible without resulting in a change in the moisture content of the product. The option of using a cooling medium to obtain the product moisture for the strand cooling following two-screw extrusion was not obvious to the person skilled in the art for the processing of thermoplastics since most known polymers exhibit little/no sorption and the cooled air generally suffices. When thermoplastics are introduced into liquid cooling media, in most cases water is used for this purpose which can be blown off or dried off.

For producing a band made of material according to the invention, the use of a chill roll and, for the relaxation of transverse and longitudinal stresses, the use of a relaxation bath (without changing the water content of the film) is likewise advantageous. Reference is made expressly to the corresponding disclosure of EP-A-1 249 219.

The processing of compounds according to the invention directly or from remelted compounds by means of extrusion and molding with flat nozzles to give a film and the use of two films in the rotary die process to give soft capsules has already been described in EP-A-1 103 254. Reference is made expressly to the corresponding disclosure.

The present invention is illustrated below by reference to nonlimiting examples.

### EXAMPLES

### Example 1

Native tapioca starch (Novation 3600, National Starch), iota-carrageenan (Satiagel USC150) or gellan (Kelcogel LT100), a softener mixture of glycerol, sorbitol syrup and maltitol syrup, and also water were used in the amounts stated below. The starch and the corresponding biopolymer on the one hand, and the softener and the water on the other hand were premixed separately and then metered into a twin-screw extruder (Coperion ZSK 25, L/D=48) using in each case one gravimetric powder metering device (the mixture of starch and biopolymer) and one liquid metering device (softener and water):

| | Ex. 1a | Ex. 1b | |
|---|---|---|---|
| | amount of | amount of | Amount of |
| Component | wet substance | wet substance | dry substance |
| Tapioca starch | 41.24 | 41.24 | 36.70 |
| (11% moisture) | | | |
| iota-Carrageenan | 5.02 | | 4.69 |
| (Satiagel USC150, | | | |
| 6.6% moisture) | | | |
| Gellan (Kelcogel | | 5.21 | 4.69 |
| LT100, 10% moisture) | | | |
| Glycerol | 10.68 | 10.68 | 10.63 |
| (0.5% moisture) | | | |
| Sorbitol syrup | 23.90 | 23.90 | 16.73 |
| (30% moisture) | | | |
| Maltitol syrup | 16.29 | 16.29 | 13.85 |
| (15% moisture) | | | |
| Water | 2.87 | 2.68 | 17.40 |

The mixtures prepared in this way were melted in the twin-screw extruder according to the following temperature profile in the different segments of the extruder and processed to give a homogeneous, thermoplastic compound:

### Temperature Profile of Two-Screw Extrusion

| T-1 | T-G2 | T-G3 | T-G4 | T-G5 | T-G6 | T-G7 | T-G8 | T-G9 | T-G10 | T-G11 | T-G12 | |
|---|---|---|---|---|---|---|---|---|---|---|---|---|
| Feed | (° C.) | (° C.) | (° C.) | (° C.) | (° C.) | (° C.) | (° C.) | (° C.) | (° C.) | (° C.) | (° C.) | Nozzle |
| RT | 100 | 100 | 130 | 150 | 150 | 130 | 120 | 110 | 100 | 100 | 100 | 95 |
| | | M | M | M | SS | SS | | | D | | | |

M = mixing; SS = strong shear, D = degassing

The following conditions were applied in the extruder:

| | | Rotation of | | Turning | Nozzle |
|---|---|---|---|---|---|
| | Throughput | extruder screw | Vacuum | moment | pressure |
| Example | (kg/h) | (rpm) | (mbar) | (%) | (bar) |
| 1a | 6.4 | 120 | 800 | 34 | 36 |
| 1b | 7.5 | 110 | 500 | 30 | 32 |

A completely homogenized material was obtained which was cooled upon exiting the nozzle until it no longer foamed.

For rapid cooling without loss of moisture, the strands were introduced into cooling medium suitable for food (medium-chain triglycerides), then cut to granules measuring ca. 2×3 mm and stored moisture-tight in PE bags.

The prepared granules were extruded in a single-screw extruder (Collin, E 30 M (screw diameter 30 mm, screw length 25D, max. turning moment 350 Nm)) according to the temperature profile below and shaped in a flat nozzle (Verbruggen) to give a band with a thickness of 0.8 mm.

### Temperature Profile of Single-Screw Extrusion

| T1 | T2 | T3 | T4 | Ad | N1 | N2 | N3 | Rotational |
|---|---|---|---|---|---|---|---|---|
| (° C.) | (° C.) | (° C.) | (° C.) | (° C.) | (° C.) | (° C.) | (° C.) | speed rpm |
| 115 | 135 | 135 | 135 | 125 | 120 | 120 | 120 | 65 |

The resulting films were conditioned in climatically controlled chambers and measured using a tensile testing machine (Instron 3345) or a pendulum impact tester (Zwick model B5102.202).

The following results were obtained under different conditioning conditions:

Impact resistance (kJ/m²)

| Conditioning conditions | Ex. 1a | Ex. 1b |
|---|---|---|
| 25° C., 50% RH | >575 | 435 |
| 30° C., 20% RH | >530 | 125 |

### Example 2

Native tapioca starch (Novation 3600, National Starch) or native potato starch (Emsize E9, Emsland), soya protein or wheat protein, glycerol or a mixture of glycerol and sorbitol syrup, and also water and glycerol monostearate were used in the amounts stated below. The starch and the corresponding biopolymer on the one hand, and the softener, the glycerol monostearate and the water on the other hand were premixed separately and then metered into a twin-screw extruder (Coperion ZSK 25, L/D=48) using in each case one gravimetric powder metering device (the mixture of starch and biopolymer) and one liquid metering device (softener and water):

| | Ex. 2a | Ex. 2b | Ex. 2c |
|---|---|---|---|
| | Amount of | Amount of | Amount of |
| Component | dry substance | dry substance | dry substance |
| Tapioca starch | 42.68 | | 52.20 |
| (11% moisture) | | | |
| Potato starch | | 50.12 | |
| (20.5% moisture) | | | |
| Wheat protein | 10.16 | | |
| (4.4% moisture) | | | |
| Soya protein | | 6.88 | 6.67 |
| (5.2% moisture) | | | |
| Glycerol | 14.47 | 25.00 | 26.67 |
| (0.5% moisture) | | | |
| Sorbitol syrup | 13.93 | | |
| (30% moisture) | | | |
| Glycerol | 0.32 | | |
| monostearate | | | |
| (0% moisture) | | | |
| Water | 18.44 | 18.00 | 14.46 |

The mixtures prepared in this way were melted in the twin-screw extruder according to the temperature profile given in example 1 in the different segments of the extruder and processed to give a homogeneous, thermoplastic compound.

In the extruder, the following conditions were applied:

| | | Rotation of | | Turning | Nozzle |
|---|---|---|---|---|---|
| | Throughput | extruder screw | Vacuum | moment | pressure |
| Example | (kg/h) | (rpm) | (mbar) | (%) | (bar) |
| 2a | 9.4 | 140 | 800 | 47 | 58 |
| 2b | 10.6 | 120 | 700 | | 45 |
| 2c | 8.0 | 120 | 800 | 32 | 41 |

A completely homogenized material was obtained which upon exiting the nozzle was cooled until it no longer foamed.

For rapid cooling without loss of moisture, the strands were introduced into cooling medium suitable for food (medium-chain triglycerides), then cut to granules measuring ca. 2×3 mm and stored moisture-tight in PE bags.

The prepared granules were extruded in a single-screw extruder as described in example 1 and shaped in a flat nozzle (Verbruggen) to give a band with a thickness of ca. 0.8 mm.

The films obtained were conditioned in climatically controlled chambers and measured using a tensile testing machine (Instron 3345) or a pendulum impact tester (Zwick model B5102.202).

The following results were obtained under different conditioning conditions:

| | Impact resistance (kJ/m²) | | |
|---|---|---|---|
| Conditioning conditions | Ex. 2a | Ex. 2b | Ex. 2c |
| 25° C., 50% RH | 550 | 490 | 305 |
| 30° C., 20% RH | 500 | 310 | 362 |

### Example 3

Native tapioca starch (Novation 3600, National Starch), kappa-carrageenan, a mixture of glycerol and sorbitol syrup, glycerol monostearate and water were used in the amounts stated below. The starch and the corresponding biopolymer on the one hand, and the softener, the glycerol monostearate and the water on the other hand were premixed separately and then metered into a twin-screw extruder (Coperion ZSK 25, L/D=44) using in each case one gravimetric powder metering device (the mixture of starch and biopolymer) and one liquid metering device (softener and water):

| | Ex. 3a | Ex. 3b |
|---|---|---|
| | amount of | amount of |
| Component | wet substance | wet substance |
| Tapioca starch | 46.74 | 42.68 |
| (11% moisture) | | |
| kappa-Carrageenan | 5.08 | 10.16 |
| (5.20% moisture) | | |
| Glycerol | 14.47 | 14.47 |
| (0.5% moisture) | | |
| Sorbitol syrup | 13.93 | 13.93 |
| (30% moisture) | | |
| Glycerol monostearate | 0.32 | 0.32 |
| (0% moisture) | | |
| Water | 19.46 | 18.45 |

The mixtures prepared in this way were melted in the twin-screw extruder according to the temperature profile given in example 1 in the different segments of the extruder and processed to give a homogeneous, thermoplastic compound.

In the extruder, the following conditions were applied:

| | | Rotation of | | Turning | Nozzle |
|---|---|---|---|---|---|
| | Throughput | extruder screw | Vacuum | moment | pressure |
| Example | (kg/h) | (rpm) | (mbar) | (%) | (bar) |
| 3a | 9.4 | 140 | 850 | 58 | 60 |
| 3b | 9.4 | 140 | 850 | 55 | 55 |

A completely homogenized material was obtained which was cooled upon exiting the nozzle until it no longer foamed.

For rapid cooling without loss of moisture, the strands were introduced into cooling medium suitable for food (medium-chain triglycerides), then cut to granules measuring ca. 2×3 mm and stored moisture-tight in PE bags.

The prepared granules were extruded in a single-shaft extruder as described in example 1 and shaped in a flat nozzle (Verbruggen) to give a band with a thickness of ca. 0.8 mm.

The resulting films were conditioned in climatically controlled chambers and measured using a tensile testing machine (Instron 3345) or a pendulum impact tester (Zwick model B5102.202).

The following results were obtained under different conditioning conditions:

Impact resistance (kJ/m²)

| Conditioning conditions | Ex. 3a | Ex. 3b |
|---|---|---|
| 25° C., 50% RH | — | — |
| 30° C., 20% RH | 141 | 179 |

### Comparative Example 1

A starch-containing compound without additional biopolymer was used in the amounts stated below and processed as in the examples according to the invention:

| | Comp. Ex. 1a | Comp. Ex. 1b |
|---|---|---|
| | amount of | amount of |
| Component | wet substance | wet substance |
| Tapioca starch | 48.07 | |
| (11% moisture) | | |
| Potato starch | | 49.41 |
| (18.0% moisture) | | |
| Glycerol | 7.76 | 4.96 |
| (0.5% moisture) | | |
| Sorbitol syrup | 14.25 | 14.65 |
| (30% moisture) | | |
| Maltitol syrup | 11.81 | 9.64 |
| (25% moisture) | | |
| Glycerol monostearate | 0.74 | 1.10 |
| (0% moisture) | | |
| Water | 17.37 | 20.26 |

In the extruder, the following conditions were applied:

| | | Rotation of | | Turning | Nozzle |
|---|---|---|---|---|---|
| | Throughput | extruder screw | Vacuum | moment | pressure |
| Example | (kg/h) | (rpm) | (mbar) | (%) | (bar) |
| Comp. | 14.0 | 110 | 500 | 55 | 60 |
| Ex. 1a | | | | | |
| Comp. | 10.5 | 120 | 500 | 75 | 78 |
| Ex. 1b | | | | | |

A completely homogenized material was obtained which was cooled upon exiting the nozzle until it no longer foamed.

For rapid cooling without loss of moisture, the strands were introduced into cooling medium suitable for food (medium-chain triglycerides), then cut to granules measuring ca. 2×3 mm and stored moisture-tight in PE bags.

The prepared granules were extruded in a single-screw extruder as described in example 1 and shaped in a flat nozzle (Verbruggen) to give a band with a thickness of ca. 0.8 mm.

The resulting films were conditioning in climatically controlled chambers and measured using a tensile testing machine (Instron 3345) or a pendulum impact tester (Zwick model B5102.202).

The following results were obtained under different conditioning conditions:

Impact resistance (kJ/m²)

| Conditioning conditions | Comp. Ex. 1a | Comp. Ex. 1b |
|---|---|---|
| 25° C., 50% RH | 790 | 617 |
| 30° C., 20% RH | 60 | 50 |

### Comparative Example 2

A gelatin compound (Gelatine 165 bloom, Gelita) without additional biopolymer was used in the amounts stated below and processed as in the examples according to the invention:

| | Comp. Ex. 2 |
|---|---|
| | Amount of |
| Component: | dry substance |
| Gelatin | 48.44 |
| (10% moisture) | |
| Glycerol | 17.68 |
| (0.5% moisture) | |
| Water | 33.89 |

For this, the water and glycerol were introduced as initial charge at 70° C. in a mixing tank with stirrer and wall heating, and the gelatin was introduced in granular form (ca. 1-3 mm grain) with stirring. The tank was evacuated and stirred at reduced pressure (ca. 200 torr) for 90 min to give a clear bubble-free solution.

The melt (hot solution) was poured into a heated flat nozzle and poured by means of gravity onto a chilled roll (18° C.) to give a film, which immediately solidified in a gum-like manner (gel). The band (the film) was removed from the cooling roll and dried in the air. The films obtained in this way were conditioned in climatically controlled chambers and measured using a tensile testing machine (Instron 3345) or pendulum impact tester (Zwick model B5102.202).

The following results were obtained under different conditioning conditions:

| Conditioning conditions | Impact resistance (kJ/m²) |
|---|---|
| 25° C., 50% RH | >560 |
| 30° C., 20% RH | 108 |

It was thus found that in the case of the starch-containing compounds and gelatin compounds from the prior art (comparative example 1 and 2), a much greater reduction in the impact resistance was observed when the materials were subjected to a higher temperature at lower atmospheric humidity.

The materials according to the invention are particularly suitable as coating materials in the production of shaped bodies. They can be used particularly preferably for producing soft capsules with the help of the rotary die process.

1-13. (canceled)

14. A homogeneous, undried, melt-extruded thermoplastic mass comprising 30-60% by weight dry substance of native or chemically modified starch, at most 11% by weight dry substance of at least one further biopolymer selected from the group consisting of carrageenan or another polysaccharide or a protein, 20-45% by weight dry substance of at least one softener, and at most 20% by weight water.

15. The mass according to claim 14, wherein said mass comprises 33-55% by weight dry substance of said native or chemically modified starch and 3 to 10.5% by weight dry substance of said further biopolymer.

16. The mass according to claim 14, wherein said softener is selected from the group consisting of glycerol, sorbitol, malitol and hydrogenated starch degradation products, or mixtures thereof.

17. The mass according to claim 14, wherein the softener content of said mass is 25 to 45% by weight dry substance.

18. The mass according to claim 14, wherein the starch is tapioca starch and the biopolymer is iota-carrageenan or soya protein or wheat protein.

19. The mass according to claim 14, wherein the starch is potato starch and the biopolymer is soya protein.

20. The mass according to claim 14, additionally comprising at least one additive selected from the group consisting of slip agents and mold release agents and aggregates.

21. A process for producing a homogeneous, thermoplastic mass according to claim 14, comprising the steps
a) mixing of 30-60% by weight dry substance of native or chemically modified starch, at most 11% by weight dry substance of at least one further biopolymer selected from the group consisting of carrageenan or another polysaccharide or a protein, 20-45% by weight dry substance of at least one softener and at most 20% by weight water
b) metered addition of the mixture obtained in step a) into an extruder and melting in the extruder at increased pressure of 10 to 300 atm, elevated temperature of at least 40° C. above room temperature, increased shear output of from 0.15 to 0.67 kWh/kg and short residence time between first contact of all components following metered addition into the extruder and exit of the molten homogeneous mixture from the extruder of at most 5 minutes, wherein the total water content of the mass is less than 20% by weight of the total mass, giving a homogeneous thermoplastic compound.

22. The process according to claim 21, wherein in step b) said melting in the extruder is carried out at a product temperature of 60-150° C.

23. The process according to claim 21, wherein in step b) said short residence time between first contact of all components following metered addition into the extruder and exit of the molten homogeneous mixture from the extruder is 3 minutes.

24. The process according to claim 21, wherein in step b) said short residence time between first contact of all components following metered addition into the extruder and exit of the molten homogeneous mixture from the extruder is 2 minutes.

25. The process according to claim 21, wherein said mass, after leaving the extruder, is introduced into a cooling medium.

26. The process according to claim 25, wherein said cooling medium is a cooling medium suitable for food.

27. The process according to claim 26, wherein said cooling medium suitable for food is a medium-chain triglyceride.

28. A molded body, comprising a shell of a homogeneous thermoplastic mass according to claim 14.

29. The molded body according to claim 28, wherein said molded body is a soft capsule.

30. A process for producing a molded body, comprising the steps
a) preparation of a homogeneous, thermoplastic mass according to claim 21,
b) molding a molded body from the compound obtained in step a) in a molding process.

31. The process according to claim 30, wherein said molded body is a soft capsule.

32. The process according to claim 30, wherein said molding process is the rotary die process.
